(19) United States
(12) Patent Application Publication
(10) Pub. No.: US 2019/0384342 A1
(43) Pub. Date: Dec. 19, 2019

(54) CURRENT MIRROR TOPOLOGY AND CIRCUIT

(71) Applicant: NXP B.V., Eindhoven (NL)

(72) Inventor: Jaume Tornila Oliver, Eindhoven (NL)

(21) Appl. No.: 16/007,938

(22) Filed: Jun. 13, 2018

(51) Int. Cl. G05F 3/26

(52) U.S. Cl. CPC G05F 3/262

(57) ABSTRACT

A staged current mirror is disclosed. The staged current mirror includes a plurality of first type current mirrors. Each of the plurality of first type current mirrors includes a plurality of transistors of a first type. The staged current mirror also includes at least one second type current mirror coupled to two of the plurality of the first type current mirrors. The second type of current mirror including a plurality of transistor of a second type that is different from the first type.

### BACKGROUND

A current mirror is a circuit designed to copy a current through one active device by controlling the current in another active device of a circuit, keeping the output current constant regardless of loading. The current being “copied” can be, and sometimes is, a varying signal current. The current mirror circuit is typically used in constant current power sources. A current mirror is a fundamental analog building block that is used to build other basic analog blocks such as comparators, operational amplifiers, etc.

The simple two transistor implementation of the current mirror is based on the fundamental relationship that two equal size transistors at the same temperature with the same V_{GS} for a MOS or V_{BE} for a BJT have the same drain or collector current.

The current mirror produces a copy of the current flowing into or out of an input terminal by replicating the current in an output terminal. An important feature of the current mirror is a relatively high output resistance which helps to keep the output current constant regardless of load conditions. Another feature of the current mirror is a relatively low input resistance which helps to keep the input current constant regardless of drive conditions. The current being ‘copied’ can be, and often is, a varying signal current. The current mirror is often used to provide bias currents and active loads in amplifier stages.

A current mirror may also be used to provide a current gain by having a plurality of transistors on the output side equal to a desired gain. For example, if a gain of 1:10 is desired, there may be one transistor on the input side and ten transistors on the output side.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one embodiment, a staged current mirror is disclosed. The staged current mirror includes a plurality of first type current mirrors. Each of the plurality of first type current mirrors includes a plurality of transistors of a first type. The staged current mirror also includes at least one second type current mirror coupled to two of the plurality of the first type current mirrors. The second type of current mirror including a plurality of transistor of a second type that is different from the first type.

In some examples, the first type is NMOS and the second type is PMOS. In other embodiments, the first type if PMOS and the second type is NMOS. Instead of NMOS and PMOS, NPN and PNP transistors may also be used. Each of the plurality of the first type current mirrors and the at least one second type current mirror includes an input port and an output port. The input port of the at least one second type current mirror is coupled to the output port of a first in the plurality of the first type current mirrors. The output port of the at least one second type current mirror is coupled to the input port of a second in the plurality of the first type current mirrors.

Further, each of the plurality of the first type current mirrors and the at least one second type current mirror includes an input side and an output side. The input side includes M number of transistors and the output side includes N number of transistors. N is greater than M. M is greater than or equal to 1 and N is greater than or equal to 2. In some other examples, N can be greater than or equal to 5.

In another embodiment, a staged current mirror is disclosed. The staged mirror includes a first type current mirror. The first type current mirror includes a plurality of transistors of a first type. The staged current mirror also includes a second type current mirror coupled to two of the first type current mirror. The second type of current mirror including a plurality of transistor of a second type that is different from the first type.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments. Advantages of the subject matter claimed will become apparent to those skilled in the art upon reading this description in conjunction with the accompanying drawings, in which like reference numerals have been used to designate like elements, and in which:

FIG. 1 depicts a circuit of a current mirror with 1:N gain;

FIG. 2 depicts a circuit of a staged current mirror with a configurable gain in accordance with one or more embodiments of the present disclosure; and

FIGS. 3-5 depict curves to show optimum number of stages for a desired gain in accordance with one or more embodiments of the present disclosure.

Note that figures are not drawn to scale. Intermediate steps between figure transitions have been omitted so as not to obfuscate the disclosure. Those intermediate steps are known to a person skilled in the art.

### DETAILED DESCRIPTION

Many well-known manufacturing steps, components, and connectors have been omitted or not described in detail in the description so as not to obfuscate the present disclosure.

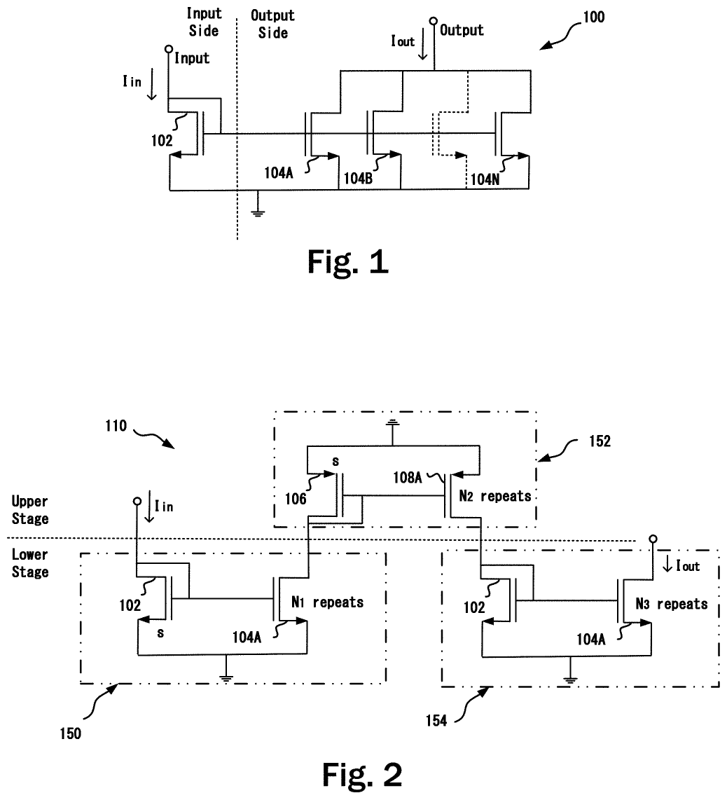

FIG. 1 shows a current mirror 100 with 1:N (where N is a positive number) gain. The current mirror 100 includes an input side and an output side. The input side includes a transistor 102. The output side includes N number of transistors 104A . . . 104N coupled in parallel. The current mirror 100 may include more than one transistor on the input side to achieve a different gain ratio as for example to achieve 2:N gain, the input side will have two transistors. For example, in FIG. 1, if the input side includes two transistors 102, a gain of 2:N may be achieved. The current mirror 100 includes an input port and an output port. Current through the input port is depicted as Iᵢₙ and current through the output port is depicted as Iₒᵤₜ. According to one characteristics of the current mirror 100, Iₒᵤₜ remains constant irrespective of the load coupled to the output port.

Depending on a desired gain, the output side needs N number of transistors 104A . . . 104N. For smaller values of N, the current mirror 100 design shown in FIG. 1 is practical. However, when a larger gain is desired, it becomes less practical to have that many number of transistors on the output side. For example, a gain of 125 will require 125 transistors on the output side.

In some embodiments, when the current mirror 100 is fabricated on a wafer, instead of having N number of transistors, each of which should be as closely identical to the transistor 102 as possible, one transistor having N times area than the transistor 102 may be fabricated. However, it is still impractical to have a larger area occupied by the transistors 104A . . . 104N on the wafer. The embodiments described herein uses a modular design that uses less number of transistors on the output side yet providing a same desired gain.

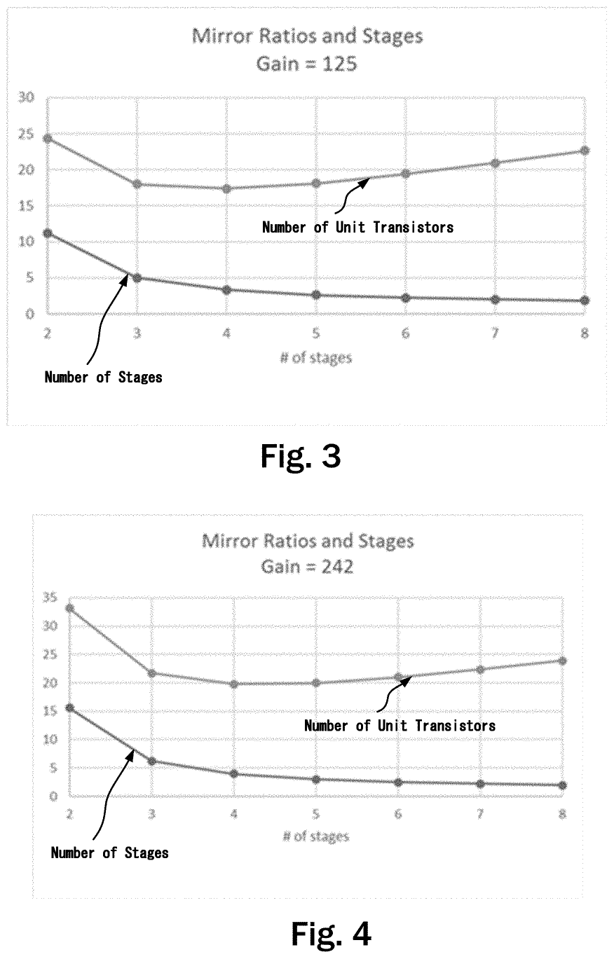

FIG. 2 shows a staged current mirror 110 having an upper stage and a lower stage. The lower stage includes a plurality of current mirrors 150, 154. The upper stage includes one or more complementary transistor type current mirror 152. In this example, the current mirror 150 is fabricated using NMOS transistors 102, 104A . . . 104N1 and the complementary transistor type current mirror 152 is fabricated using PMOS transistors 106, 108A . . . 108N2, as shown. In some embodiments, the plurality of current mirrors 150, 154 may be of type PMOS and the complementary transistor type current mirror 152 may be of type NMOS. The embodiments described herein may also be applicable to bipolar transistors NPN and PNP.

Each of the current mirrors 150, 154 includes an input port and an output port. Similarly, the complementary transistor type current mirror 152 includes an input port and an output port. The output port of the first current mirror 150 in the lower stage is coupled to the input port of the complementary transistor type current mirror 152 in the upper stage. The output port of the complementary transistor type current mirror 152 is coupled to the input port of the second current mirror 154. The current mirrors 150, 152, 154 are shown to have only one transistor on the output side for the sake of simplicity only. In fact, the current mirror 150 may include N1 number of transistors in the output side, the current mirror 152 may include N2 number of transistors in the output side and the current mirror 154 may include N3 number of transistors. In some embodiments, N1=N2=N3. In another example, N1=N3 while N1 not equal to N2. It should be noted that in some embodiments, when a current gain less than 1 is desired, the input side will have more transistors than the output side.

It should be noted that FIG. 2 shows only three stages of current mirrors. In some examples, more stages may be added to achieve higher gains. With the three stages of current mirrors shown as an example in FIG. 2, the total gain between the input port of the current mirror 150 and the output port of the current mirror 154 would be N1×N2×N3 if the input side includes only one transistor in all the three stages. For example, if N1=N2=N3=5, then the total gain will be 125.

If the number of transistors on the input side is one or more, to calculate an optimum number of transistors in each current mirror stage, N1=N2=N3 (called Ratio) will be used. However, if the input side has more than one transistors, the ratio will be number of transistors on the output side divided by the number of transistors on the input side. Total gain may then be represented as:

Gain=Ratio^{Stages}

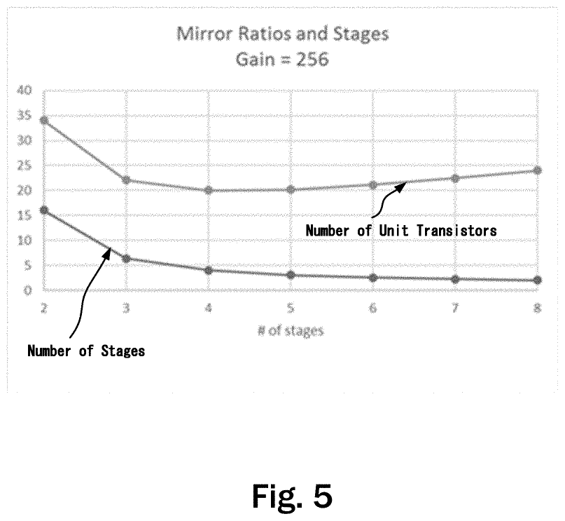

Thus, in the example of FIG. 2, for a gain of 125 where the stage ratio is 5 and there are three stages of current mirrors: Gain 125=5³. To see if that is an optimal number for the ratio and the stages, a plot, as shown in FIG. 3, can be drown. In FIG. 3, on one axis a list of integers representing the number of stages and compute what would be the required stage ratio to get the desired gain. The required ratio will be given by (EQ1):

$$Ratio = \sqrt[Stages]{Gain}$$

The total number of unit transistors to be used will be (EQ2):

N_{Unit_transitors}=Stages·(1+Ratio)

In the example of FIG. 2, the total number of unit transistors can be calculated as follows: 3*(5+1)=18-unit transistors. As shows as an example in FIG. 3, if the number of unit transistors is plotted one can find what is the number of stages and stage-ratio that gives the minimum number of unit transistors and hence the minimum area. Notice than one can get close to the optimum by doing the prime factorization (PF) of the desired gain, PF(125)⁼5³. Prime Factorization is a process of finding which prime numbers multiply together to make the original number.

As stated above, it was assumed that N1=N2=N3. However, if these numbers were to be different, the total gain can be calculated by multiplying individual gain, as follows:

Gain=R₁^{S}^{₁}·R₂^{S}^{₂}

Where R1 is the ratio for S1 stages and R2 is the ratio for S2 stages.

In another example, a gain of 242 can be achieved by one stage of ratio 2 and 2 stages of ratio 11. That is PF(242)=2*112=242. That would result in 1*(1+2)+2*(1+11)=27-unit transistors instead of 242 (using EQ2). To further reduce the number of transistors, one could implement non-integer ratios, in this example, the gain of 242 can be implemented with 4 stages of ratio 3.94. That would imply that all transistors are not equal and the mismatch would be degraded. FIG. 4 shows a plot for the gain 242.

In another example, by using 4 stages of stage-ratio 4 we get a gain of 4⁴=256 and that implies a number of unit transistors of 4*(1+4)=20 (using EQ2) instead of 257. That is also lower than 27-unit transistors to get a gain of 242 using the prime factorization as shown above. FIG. 5 shows a plot for the gain 256.

In some embodiments, the circuit of FIG. 2 will have only first two stages and the output of the second stage will be the output of the staged current mirror 110. In other words, the current limiter 110 can have the current mirror 150 and 152 only and the output of the current mirror 152 is the output of the staged current mirror 110.

The above examples consider the simplest current mirror topology for the purpose of easy explanation but embodiments are not limited to any particular current mirror implementation. Embodiments described above may also be used for different current mirror topologies such as a cascoded current mirror, Wilson current mirror, etc. As evident, by reducing the number of transistors to be used, the overall size of a current mirror can be reduced.

Some or all of these embodiments may be combined, some may be omitted altogether, and additional process steps can be added while still achieving the products described herein. Thus, the subject matter described herein can be embodied in many different variations, and all such variations are contemplated to be within the scope of what is claimed.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded to the broadest interpretation so as to encompass all such modifications and similar arrangements.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

Preferred embodiments are described herein, including the best mode known to the inventor for carrying out the claimed subject matter. Of course, variations of those preferred embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

1. A staged current mirror, comprising:
a plurality of first type current mirrors, wherein each of the plurality of first type current mirrors includes a plurality of transistors of a first type; and
an input second type current mirror coupled to an input signal and an input transistor of the plurality of the first type current mirrors; and
an output second type current mirror coupled to an output signal and an output transistor of the plurality of the first type current mirrors, wherein the second type of current mirror including a plurality of transistors of a second type that is different from the first type, wherein each of the plurality of the first type current mirrors and the at least one second type current mirror includes an input side and an output side, the input side includes N number of transistors, N being greater than or equal to 1, the output side includes M number of transistors, M being greater than or equal to 2, and M is greater than N.

2. The staged current mirror of claim 1, wherein the first type is NMOS and the second type is PMOS.

3. The staged current mirror of claim 1, wherein the first type is PMOS and the second type is NMOS.

4. The staged current mirror of claim 1, wherein the first type is NPN and the second type is PNP.

5. The staged current mirror of claim 1, wherein the first type is PNP and the second type is NPN.

6. The staged current mirror of claim 1, wherein each of the plurality of the first type current mirrors and the at least one second type current mirror includes an input port and an output port.

7. The staged current mirror of claim 6, wherein the input port of the at least one second type current mirror is coupled to the output port of a first in the plurality of the first type current mirrors.

8. The staged current mirror of claim 7, wherein the output port of the at least one second type current mirror is coupled to the input port of a second in the plurality of the first type current mirrors.

9-17. (canceled)

18. A staged current mirror, comprising:
a first type current mirror, wherein the first type current mirror includes a plurality of transistors of a first type; and
an input second type current mirror coupled to an input signal and an input transistor of the first type current mirror; and
an output second type current mirror coupled to an output signal and an output transistor of the first type current mirror, wherein the second type current mirror includes a plurality of transistors of a second type that is different from the first type, wherein both the first type current mirror and the second type current mirror include an input side and an output side, the input side includes N number of transistors, N being greater than or equal to 1, the output side includes M number of transistors, M being greater than or equal to 2, and M is greater than N.

19. The staged current mirror of claim 1, wherein the first type is NMOS and the second type is PMOS.

20. The staged current mirror of claim 1, wherein the first type is PMOS and the second type is NMOS.
